(19) United States
(12) Patent Application Publication
(10) Pub. No.: US 2016/0291637 A1
(43) Pub. Date: Oct. 6, 2016

(54) STRAP-BASED COMPUTING DEVICE

(71) Applicant: Voicelever International, LLC, Redmond, WA (US)

(72) Inventor: Stephen Albert Rondel, Redmond, WA (US)

(21) Appl. No.: 14/936,451

(22) Filed: Nov. 9, 2015

Related U.S. Application Data
(63) Continuation of application No. 13/387,348, filed on Sep. 10, 2012, now abandoned.
(60) Provisional application No. 61/229,215, filed on Jul. 28, 2009.

(51) Int. Cl. G06F 1/16

(52) U.S. Cl. CPC G06F 1/163

(57) ABSTRACT

Techniques are described for implementing and using a portable computing device that may include at least some computing components embedded in or otherwise affixed to or inserted in a belt or other strap that is worn or carried by a user, such as in one or more flaps or other enclosures of the strap, and in some situations includes some components in or otherwise interacts with a wrist-mounted device that includes various display capabilities and/or other user input/output capabilities. The computing components of the portable computing device may be inter-connected before being affixed to or inserted in a strap, or the inter-connections may be provided as part of a communication mechanism that is embedded in or otherwise affixed to the strap. If a wrist-mounted device is in use, the interactions between the portable computing device and the wrist-mounted device may occur in a wireless or wired/cabled manner.

### CROSS REFERENCE TO RELATED APPLICATIONS

This application claims the benefit of provisional U.S. Patent Application No. 61/229,215, filed Jul. 28, 2009 and entitled “Strap-Based Computing Device,” which is hereby incorporated by reference in its entirety.

### TECHNICAL FIELD

The following disclosure relates generally to a computing device having multiple interconnected components, such as may be implemented at least in part within or otherwise as part of a belt or other strap to be worn or carried.

### BACKGROUND

Computing power has been made available to users in various portable forms, including, for example, the following: laptop and other portable computers (e.g., netbook computers, tablet computers, etc.); smart phones and other portable cell phones and other communication devices, typically with limited computing power; PDAs (“personal digital assistants”) and other devices that may be handheld or stored in a holster attached to a person's clothing; SPOT (“smart personal object technology”) watches and other watches with some computing capabilities, typically limited; wearable computers (e.g., such as may be carried in a backpack or holster, and optionally bolstered with electronic textiles using electronics embedded within fabric of clothing of a user), typically with input/output devices designed for mobile use (e.g., a head-mounted display and a chording keyboard); etc. However, each of these existing types of products has various problems and limitations, including with respect to hands-free use and other aspects of ease-of-use, portability (including in real-world combinations where a user may be carrying or using various other devices and tools), computing power and other computing capabilities, ruggedness, etc.

### BRIEF DESCRIPTION OF THE DRAWINGS

FIG. 1 illustrates examples of types of intercommunications that may occur between particular strap-enclosed computer device embodiments and other data sources and destinations.

FIG. 2 illustrates examples of types of communications that may be sent to, from and/or between particular strap-enclosed computer device embodiments.

FIG. 3 illustrates an example of use of one or more strap-enclosed computer device embodiments in displaying and managing video and images from a remote vehicle.

FIGS. 4A-4D illustrate an example embodiment of a strap-enclosed computer device.

FIG. 5 is a flow diagram of an example embodiment of use of a strap-enclosed computer device.

### DETAILED DESCRIPTION

Techniques are described for implementing a portable computing device in specified manners, and for using the portable computing device in specified manners. In at least some embodiments, the implemented portable computing device includes at least some components that are embedded in or otherwise affixed to a belt or other strap that is worn or carried by a user, and in such embodiments is referred to generally herein as a strap-enclosed computer device or computing system (hereinafter “SEC device”). In addition, in at least some embodiments, the implemented SEC device or other implemented portable computing device includes some components in or otherwise interacts with a wrist-mounted (“WM”) device, such as a WM device that includes various output display capabilities and/or other user input/output (“I/O”) capabilities (e.g., speech recognition, touch input, etc.). In embodiments in which the SEC device or other implemented portable computing device interacts with such a WM device, the interactions between the SEC device and the WM device may occur in various manners (e.g., via one or more wireless links, via one or more physical cables or wires, etc.). While such other device(s) that provide I/O capabilities for or otherwise interact with an SEC device are generally referred to herein as a “WM device,” it will be understood that one or more such other devices may in some embodiments be located in a position other than on a wrist of a human wearing or carrying the SEC device (e.g., to be removably or permanently attached to the chest or arm, for example of the human; to be temporarily attachable at multiple distinct locations on the human's body; etc.). Additional details related to embodiments of SEC devices or other implemented portable computing devices, to embodiments of WM devices, and to examples of functionality provided by various such devices are included below.

For illustrative purposes, some embodiments are described below in which various specific details are included for illustrative purposes, and in some cases some embodiments are simplified for the sake of brevity so as to not illustrate well-known components. For example, in some embodiments discussed below, the implemented portable computing device is an SEC device embodied at least in part as a belt, particular SEC devices are configured to include particular computing components and to perform particular activities, particular SEC devices are configured to interact with particular types of WM devices in particular manners, etc. It will be appreciated that the inventive techniques may be used in a wide variety of other situations, some of which are discussed below.

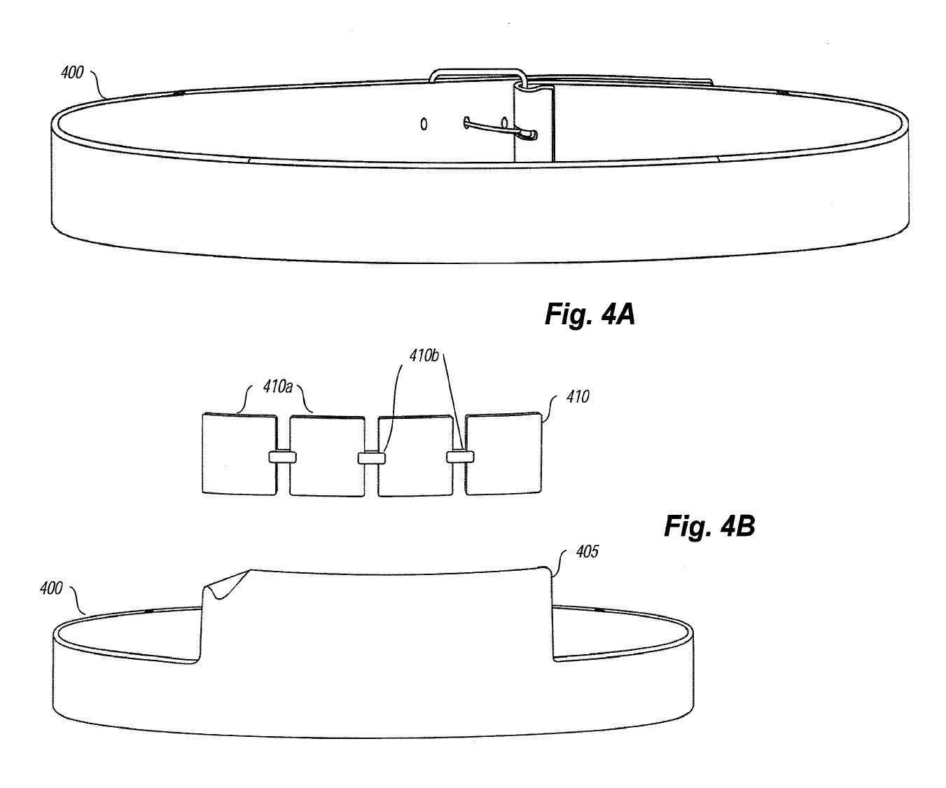

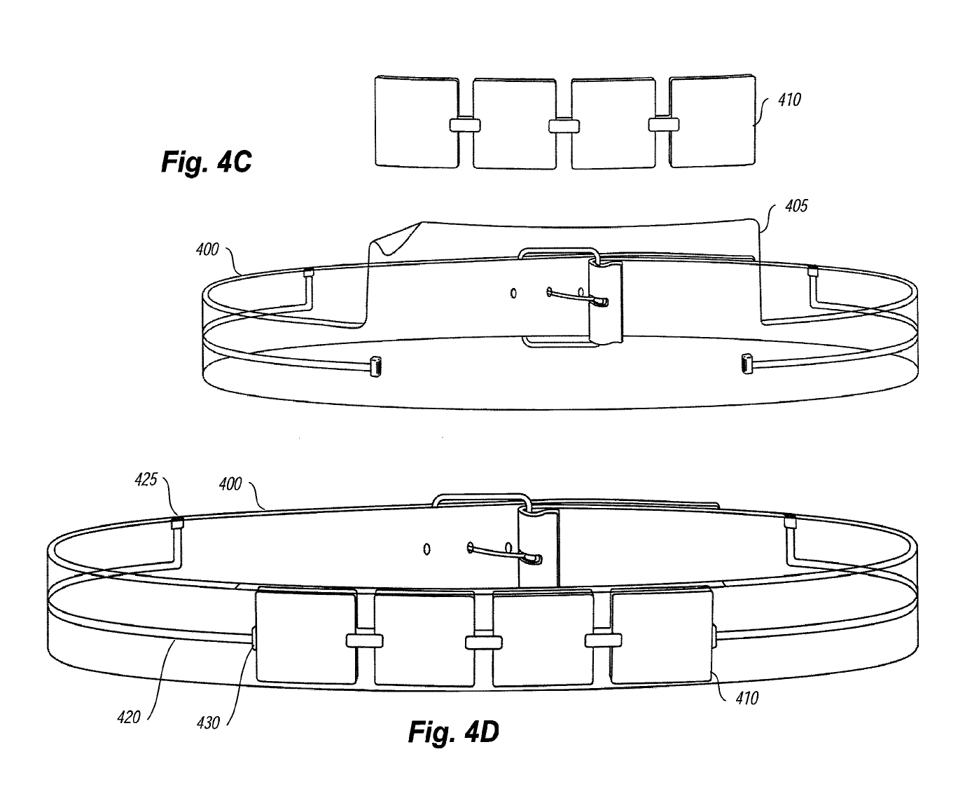

FIGS. 4A-4D illustrate examples of one embodiment of an SEC device that is provided for exemplary purposes, although it will be appreciated that the described inventive system and techniques are not limited to the details of these examples. In particular, in the examples of FIGS. 4A-4D, an embodiment 400 of an SEC device is illustrated in which a belt-type strap is shown, such as to be worn completely around a waist body part of a human user of the SEC device, and in which various computing components of the SEC device may be embedded or otherwise enclosed in one or more enclosures of the strap, or in some embodiments may be held by the strap by being at least partially enclosed by one or more enclosures that are part of or attached to the strap. For example, as illustrated in further detail with respect to FIG. 4B, the illustrated belt of this example embodiment 400 includes a single enclosure that is formed in part by a flap 405, in which one or more computing components may be enclosed for use as part of the illustrated SEC device. In this example, an enclosure area of the embodiment 400 is formed in part by the closing of an associated flap 405 (shown in the example of FIG. 4B in an open position, and being hidden in FIG. 4A based on the flap being in a closed position), with the enclosure providing room in this example for a chain 410 of four inter-connected computing components 410a. The computing components 410a in this example are of a single size (e.g., a standardized size), although in other embodiments the computing components may be of differing sizes, there may be more than one enclosure in a strap (e.g., a series of multiple enclosures in which each successive pair of enclosures is interconnected with a wiring connection mechanism, and in which some or all of the enclosures each have a distinct flap or have a single shared flap or do not have any flap), and/or there may be room for more or less than four computing components in one or all of the enclosures. In this example, the four computing components 410a of the chain 410 are inter-connected via inter-component connectors 410b in such a manner as to be handled as a single unit (e.g., to all be inserted into or removed from an enclosure area together), such as in a permanent manner that is not intended to be modifiable by a human user of the SEC device or instead in a temporary manner that is modifiable by a human user of the SEC device, and with the inter-component connectors 410b optionally including wiring or other connections to communicatively couple and facilitate inter-operation of the computing components 410a (e.g., to carry communications, such as via electrical signals; to carry power; to enable aggregate operations of multiple computing components operating together; etc.). In other embodiments in which different computing components 410a are instead enclosed in different enclosures that are interconnected via wiring connection mechanisms or other connection mechanisms, such functionality of some or all of the inter-component connectors 410b may instead be provided by the connection mechanisms between the different enclosures in which those computing components are enclosed.

FIGS. 4C and 4D illustrate additional details with respect to the example SEC device of illustrated embodiment 400. In particular, FIG. 4C further illustrates that the enclosure area for the computing component chain 410 underneath or within the flap 405 is connected via computing component connector interfaces 430 to a wiring connection mechanism or other connection mechanism 420, such that the insertion of the computing component chain 410 within the flap 405 area may in at least some embodiments automatically create a connection between the computing component chain 410 and the computing component connector interfaces 430 (so as to communicatively couple the computing components of the chain 410 to one or more connection mechanisms 420), such as based on the physical dimensions of the flap 405 area and of the component chain 410 (e.g., based on at least a portion of the computing component connector interfaces 430 extending into one or both ends of the enclosure area of flap 405 sufficiently to each make removable physical contact with an enclosed removable computing component, such as via a connector 410c (not shown) on the end of that removable computing component adjacent to that interface 430, so as to removably physically and communicatively couple that removable computing component thereto, and with other optional removable computing components included in the enclosure being communicatively coupled to that interface 430 via one or more intervening removable computing components in the enclosure and via inter-component connectors 410b therebetween the removable computing components). In this example, each connection mechanism 420 is embedded within the belt, and is attached to one or more external ports or other access point interfaces 425 for the SEC device, so as to communicatively couple the access point interfaces to one or more computing component connector interfaces 430, and via the computing component connector interface(s) 430 to any computing components enclosed within the enclosure area of the flap 405. One or more of the access point interfaces 425 may in turn enable one or more devices external to the belt strap to be communicatively coupled to the strap, and in particular to any computing components enclosed within the enclosure area of the flap 405 via the access point interface(s) 425, connection mechanism(s) 420, and computing component connector interface(s) 430. In other embodiments, access to some or all of the functionality of the computing component chain 410 within the enclosure area of the flap 405 may be in manners other than via cables or other wires from the external device(s) to the access point interfaces 425, such as via wireless connections to the access point interfaces 425 or otherwise to one or more computing components within the enclosure area of the flap 405, and/or the connection mechanism 420 may have forms other than being embedded in the belt. In addition, while the embodiments illustrated in FIGS. 4C and 4D include multiple access point interfaces 425 on both sides of the strap outside of the enclosure(s) area, in other embodiments the SEC device may include one or more access point interfaces on only a single side of the enclosure(s) area, such as based on a connection mechanism only on that side of the enclosure(s) area that interconnects the enclosure(s) and those one or more access point interfaces. In other embodiments, no such access point interfaces and/or connection mechanisms outside the enclosure(s) area may be used, such as if the computing components interact with any external devices via wireless connection mechanisms and/or via one or more wiring connection mechanisms that extrude directly from one or more of the enclosure(s) area. Furthermore, various embodiments may use various techniques to protect the computing chain 410 and/or the belt or other strap of the embodiment 400, such as from the following non-exclusive list: to have some or all of the computing components 410a individually be waterproofed, cushioned to protect from impact, shielded from radiation or other energy or electrical signals, or otherwise protected from environmental conditions and/or human-initiated conditions (e.g., directed energy, electrical signals, heat or cold, water, shock waves or other impact, etc.); to have the computing chain 410 in its entirety be protected in one or more such manners from such environmental conditions and/or human-initiated conditions (including being waterproofed, cushioned to protect from impact, shielded from radiation or other energy or electrical signals, etc.); to have the flap 405 and/or other portions of the belt be protected in one or more such manners from such environmental conditions and/or human-initiated conditions (including being waterproofed, cushioned to protect from impact, shielded from radiation or other energy or electrical signals), etc. Thus, in an enclosure area of a strap has an associated flap, the flap may serve one or more purposes when closed, including to provide one or more types of protection to any computing components enclosed within the flap, to inhibit access to any computing components enclosed within the flap (and to corresponding provide access to any such computing components enclosed within the flap when the flap is open), to inhibit visibility of any computing components enclosed within the flap, etc. In will be appreciated that other embodiments may vary in other manners.

As previously noted, a belt-based SEC device or other SEC device may include a variety of separate computing components that are interconnected in various manners. For example, such separate computing components may in some embodiments be based on various computer ports for connecting peripherals (e.g., USB, microphone, speaker, Ethernet, VGA display, DVI display, etc.), such as to separate some or all such ports into separate small electronic modules (e.g., to have a first port to provide USB capabilities as part of a first computing component, to have a second port to provide or access microphone capabilities as part of a second computing component, etc.). In other embodiments, different computing components may separate some or all of various other types of components of a computer (e.g., CPU or other processors, RAM and other volatile memory, non-volatile storage, particular I/O devices, etc.), such as to have one or more first computing components that each includes one or more CPUs or other processors in order to provide a specified amount of computing capabilities, and to have one or more other second computing components that do not include any CPUs or other processors or otherwise provide any computing capabilities but each does provide a specified amount of one or more other types of capabilities, such as volatile memory capabilities (e.g., by including a specified amount of RAM), non-volatile storage capabilities (e.g., by including a specified amount of storage space on a hard disk or flash memory or other storage mechanism), one or more input/output capabilities, one or more communications capabilities, etc. The following includes a non-exclusive list of example capabilities and components of an SEC device and/or a connected WM device: may be operated by speech (e.g., via automated speech recognition capabilities) and/or touch; provides speech-to-text, talk-to-type and/or text-to-speech capabilities, such as via automated speech recognition capabilities; includes vibration and/or audio capabilities; includes an accelerometer; includes a micro-head cam option on a headset microphone; is physio-sensor adaptable; provides instant or near-instant voice and/or camera communications; provides positive skin contact for guaranteed contact; is networked on-body to a cell phone; has wired and/or wireless on-body capabilities; is enabled to use Wi-Fi and/or cell phone communications for off-body inter-communication with other computing systems remote from a human user of the SEC device (e.g., other proximate SEC devices being used by other nearby humans, such as other humans operating in a coordinated manner with the human user of the SEC device); has an ultra high-definition display; has a wearable display/skin sensor (e.g., a WM device with a two-way touch screen on top, and a skin touch “sensor” on the back to sense user condition, with the WM device optionally being a clam-shell or other form factor that can be opened to access additional display and/or input capabilities); two-way tele-video; etc. One example configuration includes a 1.6 GHz processor running the Windows XP or Linux operating system, with 2 gigabytes of memory and 250 gigabytes of solid state storage. It will be appreciated that various additional capabilities and components may be provided in some embodiments, and that some embodiments may not include some or all of the identified capabilities and components.

The various computing components of a particular SEC device may be connected in various manners, such as to communicatively couple multiple removable computing components together (e.g., temporarily until one or more of the computing components are removed from the connection with the other computing components or otherwise removed from the SEC device) via one or more physical inter-component connectors 410b or otherwise via one or more wires or other connection mechanisms between enclosures of a strap of the SEC device in which the computing components are enclosed, so as to enable the communicatively coupled computing components to exchange electrical signals or otherwise communicate with each other (e.g., to enable multiple computing components to aggregately perform one or more activities on behalf of the human user of the SEC device or to otherwise aggregately provide one or more capabilities). For example, when the computing components are fixed in a permanent or semi-permanent location on a strap, the various computing components may each be connected by various types of interconnection mediums (e.g., flexstrips or other flexible film connectors, wire bundles, etc.) that act as such connection mechanisms, with the interconnection mediums optionally integrated into the strap or instead being separate from the strap. In addition, in at least some embodiments, the electronics are implemented at the lowest possible physical size levels, such as through miniaturization via small parts and/or via part consolidation (e.g., using ASICs, ball grid arrays, die shrinks, multilayer printed circuit boards, etc), so as to shrink the form factor to a size small enough to fit in a belt or other strap.

In some embodiments, the various separate computing components may be arranged in a linear or near-linear manner, such as to conceptually be referred to as a computer “train” that has numerous inter-connected “cars”, or as a “chain” with various interconnected links. In other embodiments, the various separate computing components may be arranged in other manners (e.g., for at least some computing components to be connected in parallel, optionally while other computing components are connected in a serial manner)—for example, as one illustrative embodiment, multiple computing components may in some embodiments be arranged in a grid fashion that includes inter-component connections in at least two dimensions, such as within a vest or backpack to be worn on a human user of the SEC device. Furthermore, some components may be separate from but nonetheless connected with the “train”. For example, some types of peripheral devices may be fastened to the strap (e.g., in dedicated holster enclosures or other container enclosures that are permanently or temporarily affixed to the strap) in such a manner as to be wired into the “train” on mechanical contact, such as batteries, cables for a hardwired system, etc. Such connections may be particularly useful for components that may be replaced regularly (e.g., batteries) or otherwise used only intermittently, such as for computing components of an SEC device embodiment that may be modified for different tasks (e.g., to temporarily replace a computing component providing excess memory or computing processor(s) with another computing component that provides specialized communication capabilities). As one example, a particular strap may be designed to include one or more primary battery holsters, in which the batteries that are present are actively available to supply power to support the SEC device, and may further optionally include one or more other secondary battery holsters (e.g., to hold spare batteries, such as may be manually moved by the user to a primary holster when needed, or to instead be automatically accessed in the spare battery location if needed). Furthermore, in some embodiments, one or more WD devices may be connected to and part of a particular SEC device, whether through physical cable or wired connections to one or more access point interfaces 425 in a strap of the SEC device, or instead via wireless communications. Other specialized devices external to the strap of an SEC device may similarly be interconnected with the computing components in the strap and/or the WM device(s) in at least some embodiments, whether through physical cables or wires to one or more access point interfaces 425 or instead in a wireless manner, such as a head-mounted microphone, earbuds or other speakers, a video cam (e.g., a head-mounted or chest-mounted or shoulder-mounted video cam), etc.

The integration of the computing components within one or more enclosures of or otherwise affixed to a strap of an SEC device is further performed in some embodiments in a manner such that the interconnected components are sufficiently independent (in terms of strength and structure) of the strap that the transmission of mechanical tension, shock, twist, etc. from the strap to the interconnected computing components is minimized or eliminated. In addition, various mechanical means may be used to shield the interconnected computing components from mechanical forces applied to or resulting from the strap, such as via strain reliefs and slippery surfaces. In some embodiments, the material used for the strap provide high tensile strength with minimal thickness, such as via a flexible substrate that is part of the strap (e.g., stainless steel fabric, nanothread fabric, nylon fabric, other homogeneous material, etc.), so as to better accommodate the width of various computing components that are integrated within or otherwise affixed to the strap, although in some embodiments more conventional materials for a flexible substrate of a strap (e.g., leather, plastic, rubber, etc.) may be used in whole or part. Furthermore, to accommodate different user sizes and body part attachment locations, the strap of an SEC device may in some embodiments be designed to have a modifiable length or other modifiable dimensions, such as to be able to attach to different extension pieces, to wrap back onto itself, to be attached to a physical mechanism that allows retraction and extraction, etc. As such, in use such a strap forms a closed surface having an opening with an adjustable size to enable a length of the strap to be modifiable, so as to enable attachment to multiple distinct human body parts of one or more humans at distinct times. In addition, in some embodiments the strap of an SEC device may be a single connected piece of material that is not designed to be separable by a human user of the SEC device (e.g., a strap having elastic properties to provide a modifiable length when pulled to or otherwise positioned around a human body part), while in other embodiments the strap may include two opposed ends that are configured to detachably couple (e.g., a belt having a buckle at one end and holes or other fastening mechanisms at the other end to detachably couple to the buckle) to enclose at least a portion of a human body part. The chain of connected computing components may in various embodiments be all enclosed within the material of the strap, may be all attached to a single external side of the strap (e.g., so as to fit into a cavity enclosure created within the strap) that is facing inward to the user's body or outward from the user's body, or have varying locations. Various locations may be beneficial for particular types of desired capabilities, such as to provide better protection from the environment if enclosed within the material of the strap, or to provide better access for modification or maintenance if attached to an external side of the strap.

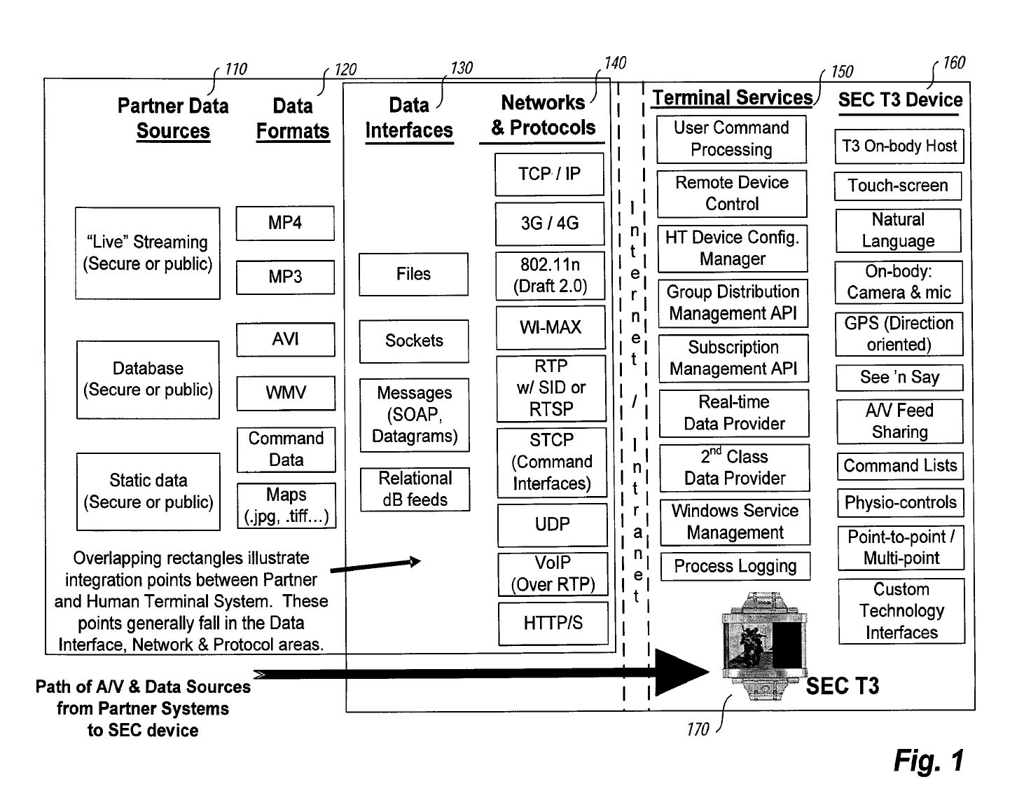

In addition, particular embodiments of the SEC device may be configured to provide a variety of types of capabilities and to use a variety of types of technologies, such as in conjunction with one or more modules on a SEC device that are designed and/or configured to provide particular types of functionality. For example, FIG. 1 illustrates types of intercommunications that may occur in some embodiments between particular SEC device embodiments and other data sources and destinations, with a particular SEC device embodiment 160 referred to in this example as a “T3” device. In this example, the SEC device 160 may interact with various external partner data sources 110, such as to receive information from and/or supply information to such external data sources, including secure or public databases, secure or public static data, and secure or public live streamed data. In addition, various data formats 120 may be supported (e.g., MP4, MP3, AVI, WMV, command data, maps in various image formats such as JPG and TIFF, etc.), as well as various data interface mechanisms and protocols 130 (e.g., files, sockets, structured messages (such as for SOAP or datagrams), relational database feeds, etc.), and various networks and protocols 140 (e.g., TCP/IP, 3G and/or 4G, 802.11n or other forms of 802.11 WiFi, WI-MAX, RTP (such as with SID or RTSP), STCP command interfaces, UDP, VoIP (such as over RTP), HTTP and HTTP/S, etc.). Furthermore, the example SEC device 160 may support various terminal services 150 (e.g., user command processing, remote device control, HT device configuration manager, group distribution management API, subscription management API, real-time data provider integration, 2^{nd} class data provider integration, Windows service management, process logging, etc.), as well as provide a variety of components and capabilities 160 (e.g., a touch screen, an on-body host, natural language capabilities, an on-body camera and/or microphone, direction-oriented GPS or other GPS, See 'n Say voice-based capabilities or other speech recognition capabilities, NV feed sharing, command lists, physio-controls, point-to-point/multi-point, custom technology interfaces, etc.). In this example, a visual illustration 170 is included of an example WM device that is used as part of the SEC device 160 for input and output. It will be appreciated that the various example types of information illustrated in FIG. 1 may have other forms in other embodiments, including to use additional types of capabilities that are not illustrated here and/or to not include some or all of the illustrated types of capabilities.

Furthermore, particular embodiments of the SEC device may be designed and/or configured for particular applications, or otherwise used in particular manners. A non-exclusive list of possible applications and environments for the SEC device include healthcare activities (e.g., with a particular human user of an SEC device acting in a role as a doctor, nurse, paramedic, etc.), military, law enforcement activities, security-related activities (e.g., with a particular human user of an SEC device acting in a role as a night watchperson, a security guard, a bodyguard, etc.), firefighting activities, activities performed by executives and other professionals, industrial use activities, etc. Embodiments of the SEC device may enhance a wearer's ability to capture, communicate and coordinate information with others, such as while on the move (e.g., with hands and/or eyes already busy), working, and under stress, including in some situations to provide constant or recurrent situational awareness. The SEC device may be configured and operated to gather and display various information (e.g., video, voice, maps, the wearer's human condition, etc.) through an interface that can be operated “hands free” using speech recognition, such as to enable a human user of the SEC device to provide voice-based commands to the SEC device to effect desired operations by or functionality of the SEC device. If included, a WM device or other wearable display and headset microphone may further provide persistent skin contact.

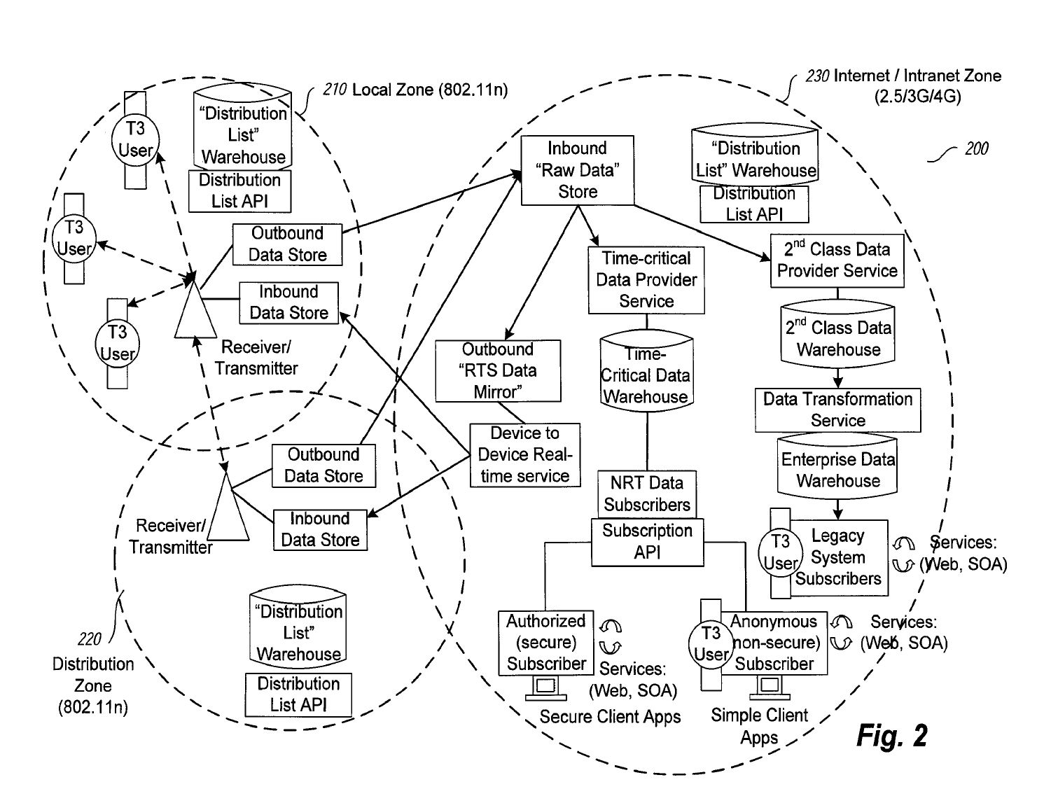

As one particular example, the use of multiple SEC devices by multiple users may assist those users to interact, such as to coordinate activities of a group. FIG. 2 illustrates examples of types of communications that may be sent to, from and/or between SEC devices in some embodiments. In particular, FIG. 2 illustrates a network diagram 200 of several inter-connected communication zones, which in this example include a local zone 210, a distribution zone 220, and an Internet/Intranet zone 230. In this example, the local zone 210 may include various human users that each are using an embodiment of an SEC device, referred to in this example as a “T3 user”—such users may in some embodiments and situations be unrelated to each other except for being geographically proximate, while in other embodiments and situations some or all such users may be acting together in a coordinated manner (e.g., may be part of a common military unit, or other type of common squad or group, or may otherwise be engaged in similar or complementary or the same activities). The various SEC device users in this example may interact with each other within the local zone, such as in a direct manner or via one or more intermediate receivers/transmitters. It will be appreciated that various security and authentication techniques may further be used to limit communications in some such embodiments to authorized users, as well as to otherwise control access of particular users to particular information (e.g., such as based on distribution lists or other access rights that are maintained on one or more of the SEC devices and/or in one or more other centralized locations). In this example, one or more devices in the local zone 210 have the ability to communicate with one or more devices in the distribution zone 220, such as if one or more central receivers/transmitters in the local zone 210 are able to intercommunicate with one or more receivers/transmitters in the distribution zone 220. In this example, the distribution zone 220 may serve to interconnect multiple local zones (not shown) either with each other and/or with one or more external Internet/Intranet zones 230, which may include a wide variety of users and computing systems. In this example, the distribution zone 220 is enabled to communicate with the Internet/Intranet 230, such as to access a variety of such data sources and capabilities.

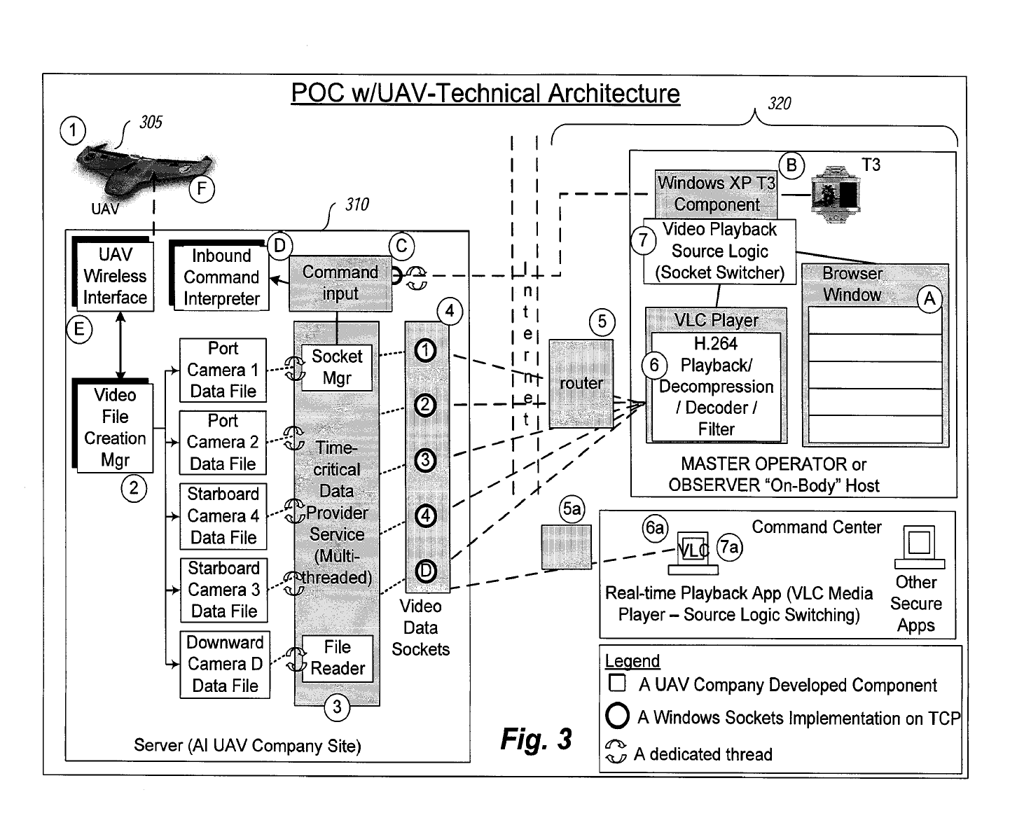

FIG. 3 illustrates a further example of one particular use of SEC devices, such as may be implemented as a specialized embodiment of the configuration illustrated in FIG. 2. In particular, in the example of FIG. 3, SEC devices are used to bring video and images from small, soldier-launched UAVs (“unmanned aerial vehicles”) to members of a special forces unit operating in a coordinated manner and in a proximate manner, in what is referred to in the example as a semi-autonomous Micro Tactical Surveillance System. In this example, a particular UAV 305 may be in communication with a computer server 310, which provides corresponding information to one or more SEC devices 320 and/or other computing devices. In this type of system, video and image information may be pushed to and/or pulled from cameras on soldiers, UAVs and SUGVs (“small unmanned ground vehicles”), under voice and/or touch command. By superimposing such information on and with terrain maps and positional data regarding team members and other assets, situational awareness and communications may be facilitated on an unprecedented level and scale.

The following are examples of types of commands, supplied via voice and/or touch, that SEC devices may use to direct information on-body and off-body, when being used by an autonomous tactical warfighter unit in an environment such as those of one or more of FIGS. 1, 2 and 3. Such functionality may be used by one or more input/output components that are implemented in hardware and/or software and that are executed by a particular SEC device embodiment, such as a speech recognition and response component and/or a touch recognition and response component.

Drag your finger across a map display to move it left, then up, but while wearing gloves, and with the SEC device in a ruggedized form that can handle battlefield conditions.

Say “zoom-in” while a map is displayed, then touch a spot of interest on a displayed map and say “UAV, take position,” and hear in response, “UAV confirms 18.22N, 22.44E”. The SEC device may then receive and display realtime vision of that terrain from the UAV.

Ask for a visual display of all positions (e.g., “Computer, show team locations”), and see each soldier's position superimposed on the terrain map.

Tell a particular other user to see what you see (e.g., by simply saying “Look Jim, see, He's in the window. Right there”, and with his head cam guiding him to the appropriate azimuth, position and range, by the sender first calculating the X,Y,Z position of the special point of interest through the geometry defined by the azimuth, angle of inclination, and range to the special point of interest coming through their camera and aligned with their range finder, compass and altitude, compute the longitude, latitude, and altitude of the special point of interest, mark the position, and then translate that position onto the camera view of the receiver to produce a locator that is line of sight to the special point of interest (or he may instead be able to see through your head cam).

“Computer, what are Sgt Berman's allergies and medications?”

“Central, I need medical advice NOW for this injury I'm looking at!”

“Sam, you're overheating, your inside helmet temperature is 104.”

“Computer, show me what this area looked like last night.”

“Ted, talk to me and show me your cam at a little left of your current view.”

Saying another user's name may, for example, prompt a module provided on the SEC device to automatically direct a message to that other user, such as “Joe Murdock look at this!,” or using phonetics for the destination individual or group, “Juliet Mama, look at this”. Conversely, if a user command includes an actionable event, a module provided on the SED device may automatically respond. Users can quickly reach command centers, team members, and key tactical information without putting their work down. This creates the potential to empower a “hands- busy, eyes-busy” user with the ability to collaborate and coordinate, on the move, under stress, in a more timely and accurate manner, generating more complete and timely information for all concerned.

Thus, various embodiments of the SEC device may be used in a wide variety of situations to provide a wide variety of benefits.

Furthermore, as previously noted, the form factor of an SEC device may have various forms in various embodiments. For example, in some embodiments an SEC device may include various computing components that are embedded within a belt, with the fabric of the belt or a communication substrate within the belt used to carry electrical signals between or otherwise interconnect the various computing components. In other embodiments, an SEC device may have other forms, such as included in the following non-exclusive list: the strap of a purse or other bag that is carried over the shoulder or on an arm; the strap of a backpack or other bag that is worn over the shoulder or otherwise attached to any part of the body (e.g., the strap of a fanny pack); as part of suspenders or a sash; as part of a tie; as part of a hatband; as attached along a longitudinal portion of a piece of clothing (e.g., pants, a shirt, a dress, a skirt, etc.), such as along a pants inseam (whether on the inside of the pants or the outside), along the sleeve of a shirt or blouse, etc. Accordingly, embodiments of an SEC device may have various forms.

In addition, in some embodiments, the various computing components that are part of a particular SEC device embodiment may be permanently affixed to each other, such as to be included within a belt and integrated with each other using wires between various of the computing components. In other embodiments, some or all of the computing components of a particular SEC device embodiment may be affixed in other manners, including in a modifiable arrangement. For example, in some embodiments, at least some of the computing components that may be used as part of a particular SEC device may be provided in an individual fashion, such as to enable particular ones of the computing components to be selected and attached together at a later time, such as at a time of use or a time of sale (e.g., to enable end-user selection and configuration of desired capabilities). Furthermore, in at least some such embodiments, the various computing components may continue to be modifiable even after an initial construction and use of the combined computing components, such as to enable particular computing components to be swapped out or otherwise removed and to be replaced with other computing components, to allow new computing components to be added, and/or to allow existing computing components to be removed without being replaced.

For example, in some embodiments, the computing components may be designed to communicate with each other in a fashion that enables interconnections to be dynamically made (e.g., via wireless connections) or may be quickly physically attached (e.g., via standardized physical connections that enable different computing components to be selected and easily attached to each other in a matter of seconds or minutes). Such embodiments enable not only customization of a particular instance of an SEC device, such as may be specified in accordance with the desires of a user of the device, but also enable various computing components to be treated as being optional or alternatives. For example, each SEC device may include at least one processing component that has one or more computer processors and a specified amount of computing capabilities or power (e.g., CPU cycles). In such situations, a particular user may choose to configure a particular SEC device to have a desired amount of computing capabilities or power by including multiple such standardized processing components so as to reach an aggregate desired amount of computing capabilities or power, or alternatively, different processing components with different amounts of computing capabilities or power may be available and selected between. Other types of components, such as a video camera component, may be optional in some situations, such that a first user may choose to include a video camera component as part of an SEC device that the first user configures, while a second user may configure a second SEC device that does not include video camera component. Furthermore, in embodiments in which a particular SEC device is modifiable even after initial configuration and use, a particular user may choose to upgrade or otherwise modify particular components, such as to enable the second user to later add a video camera component to the second SEC device, and/or to enable the first user to replace the initial video camera component with another video camera component of the same or differing type (e.g., a working copy of the same video camera component, such as if the first video camera component has stopped functioning; an upgrade video camera component that includes high-definition capabilities; etc.). It will be appreciated that in some such embodiments, there may be some types of constraints or preferences applied in certain circumstances, such as related to the order or arrangement of particular computing components (e.g., to have volatile memory capabilities near computing capabilities), to restrict or standardize distances between components, etc.

In addition to enabling the computing components of a particular SEC device to be customized and otherwise configured, in some embodiments the enclosure for a particular SEC device may itself be customizable or modifiable in various ways. For example, in embodiments in which the enclosure for the SEC device is a belt, the belts in which the SEC devices are enclosed may be of a standardized width and/or length. In addition, the belt or other strap-based enclosure may be configured to be enclosed within different sheaths (e.g., of different colors, materials, patterns, etc.) to cover the belt enclosure of the SEC device, such as for fashion purposes, different visual appearances (e.g., camouflage), or for particular functionality (e.g., to have a waterproof sheath, a ruggedized sheath with additional padding or other protection, an energy shield sheath designed to block and/or allow certain types of radiation or other types of energy or electrical signals); etc. In addition, in some embodiments there may be various attachments to a particular SEC device enclosure that may be added or modified, such as to enable various belt buckles to be added to or modified on a particular SEC device belt. Furthermore, in embodiments in which some or all of the computing components of a particular SEC device may be user selectable and modifiable, the particular SEC enclosure to which those selected computing components may be affixed may be modifiable, such as to have various alternative SEC device enclosures from which a user may select. In such embodiments, the particular selected computing components may be affixed to a particular SEC device enclosure in various manners, such as to be affixed in various manners to the outside or the inside of a belt, or to enable the SEC enclosure to close around and encase the selected computing components.

Furthermore, as discussed elsewhere, a user may provide input to a particular SEC device embodiment in various manners, with the input mechanisms in at least some embodiments being configurable based on particular types of input devices with which a particular SEC device is constructed. For example, in some embodiments in which various computing components are enclosed within a belt or other strap of a particular SEC device enclosure, one or more other computing components of the SEC device may be separate from that enclosure, such as if the user is using a WM device for input and/or output. In such situations, the WM device may, for example, communicate with other computing components of the SEC device via wireless communications (e.g., Bluetooth 2.0, wireless USB, Wi-Fi 802.11n, WiMAX, infrared, etc.), while in other embodiments a physical cable or other connection may be made between the SEC device enclosure and the WM device (e.g., on a temporary basis, such as to enable high-bandwidth communication such as video transfer; on a permanent or semi-permanent basis, such as if the SEC device enclosure is on or near the arm of a user and a physical cable is used to connect to the WM device on the wrist of the user, etc.). Furthermore, as previously noted, in some embodiments the WM device may accept voice input from the user and/or provide voice output, such as by using a microphone and/or speaker components within the WM device, or instead by using separate devices with which the WM device and/or the computing components of the SEC device inner-communicate (e.g., a wireless microphone worn by the user, a wireless earbud, etc.). Furthermore, as previously noted, in some embodiments a particular SEC device may have a variety of other types of input and/or output devices, such as a head-mounted display or other heads-up display, a chording keyboard, touch input (e.g., multi-touch) on the WM device or other display device, etc.

In addition to the various components of an SEC device inter-communicating with each other, in some embodiments a particular SEC device may be configured and enabled to communicate with other external devices. For example, in some embodiments multiple SEC devices may be configured to inter-communicate with each other using various types of wireless communications, such as to enable multiple users of a group to interact in a coordinated and/or proximate manner. Such a group may include, for example, members of a military unit, a group of friends (e.g., as part of a social network application or use), multiple employees of a single business or other organization, etc., and each of the users may have one or more designated roles to perform as part of such a group. In other embodiments, a particular SEC device may be enabled to communicate in a wireless manner with any designated recipient, such as to enable communications using a cell phone connection and/or a computer network connection (e.g., a Wi-Fi network, a WiMAX network, etc.) to other communication devices and/or computing devices.

Furthermore, in at least some embodiments, a particular SEC device may be configured to communicate with external devices in order to provide additional capabilities to the SEC device. As one example, a particular SEC device may be configured with little or no non-volatile storage, and if so may use a wireless connection to an external storage device or location to facilitate operations of the SEC device (e.g., to stream audio or video data to the SEC device from an external location for display or other presentation to the user, to stream audio and/or video data from the SEC device to an external storage location, such as to enable long-term storage of information that is recorded or otherwise sensed by the SEC device, including from the user of the device and/or an environment of the SEC device; etc.). Various other types of specialized and/or standard capabilities may similarly be provided external to and accessed by an SEC device in at least some embodiments.

As noted above, various modules or systems may in some embodiments be provided as part of a SEC device in order to provide particular capabilities. Alternatively, in other embodiments some or all of the modules and/or systems may execute on another device and communicate with the SEC device via inter-computer communication. Furthermore, in some embodiments, some or all of the modules may be implemented or provided in various manners, such as partially or wholly in software (e.g., to include software instructions that are executable on a CPU or other programmable or configurable processor, such as while loaded in volatile memory after being stored on a non-volatile storage medium), and/or such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. System modules or data structures may also be stored as contents (e.g., as executable or other machine-readable software instructions or structured data) of a computer-readable medium (e.g., as a hard disk; a memory; a computer network or cellular wireless network or other data transmission medium; or a portable media article to be read by an appropriate drive or via an appropriate connection, such as a DVD or flash memory device), so as to enable, configure, and/or program the computer-readable medium and/or one or more associated computing systems or devices to execute or otherwise use or provide the contents to perform at least some of the described techniques. Some or all of the system modules and data structures may also be transmitted as contents of generated data signals (e.g., a by being encoded in a carrier wave or otherwise included as part of an analog or digital propagated signal) on a variety of computer-readable transmission mediums, including wireless-based and wired/cable-based mediums, may take a variety of forms (e.g., as part of a single or multiplexed analog signal, or as multiple discrete digital packets or frames), and may similarly enable or configure the computer-readable transmission medium and/or one or more associated computing systems or devices to execute or otherwise use or provide the contents to perform at least some of the described techniques. Accordingly, the inventive techniques may be practiced with various system configurations.

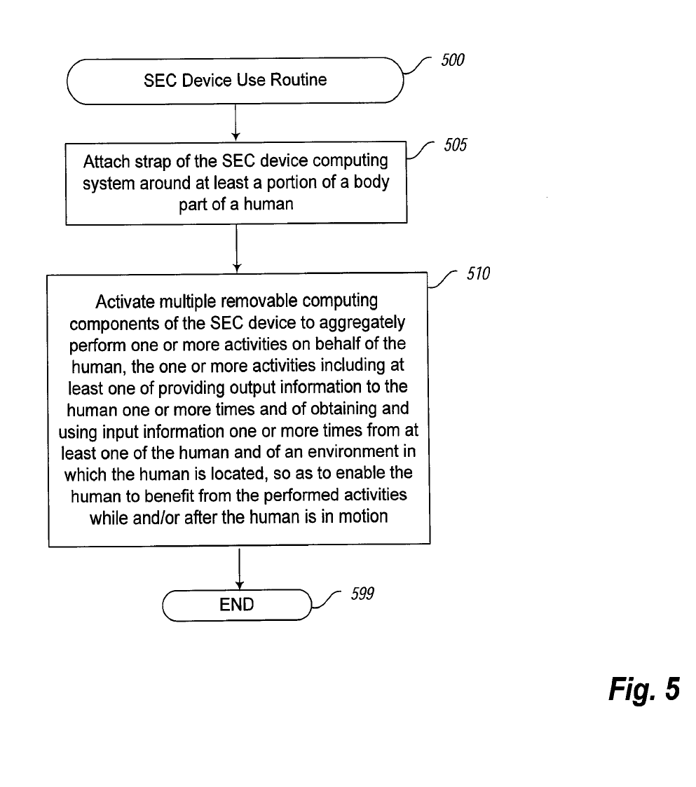

FIG. 5 is a flow diagram of one example embodiment of use of a strap-enclosed computer device. In the illustrated routine 500, at block 505, the strap of an SEC device computing system is attached around at least a portion of a body part of a human. At block 510, multiple removable computing components of the SEC device that are enclosed in one or more enclosures of the strap are activated, such as by the human or in an automated manner (e.g., based on insertion of one or more of the multiple removable computing components in an enclosure; based on a timer expiration or other scheduled occurrence; based on detection of an external signal or other stimuli, optionally from a remote computing system; etc.). Once activated, the multiple removable computing components of the SEC device operate in an aggregate manner to aggregately perform one or more activities on behalf of the human and/or to otherwise aggregately provide one or more capabilities, such as by providing output information to the human one or more times and/or by obtaining and using input information one or more times from at least one of the human and of an environment in which the human is located. As discussed in greater detail elsewhere, the aggregately performed activities or other aggregately provided capabilities may occur a single time or may include multiple repeated interactions over an extended period of time (e.g., minutes, hours, days, months, etc.), may enable the human to benefit from the performed activities while and/or after the human is in motion, may be performed with respect to a variety of types of activities and/or roles of the human, may include coordination with other related users who are operating in a proximate and/or coordinated manner with the human wearing the SEC device, etc.

It should also be appreciated that in some embodiments the types of functionality discussed above may be provided via various computer-implemented routines that are performed, including the routine described with respect to FIG. 5 and other routines (not shown). Similarly, in some embodiments, capabilities of such routines may provide more or less functionality than is described above. In addition, while various operations may be illustrated or described as being performed in a particular manner (e.g., in serial or in parallel, or synchronous or asynchronous) and/or in a particular order, in other embodiments the operations may be performed in other orders and in other manners. Data structures may also be structured in various manners, and may store more or less information than is described.

From the foregoing it will be appreciated that, although specific embodiments have been described herein for purposes of illustration, various modifications may be made without deviating from the spirit and scope of the invention. In addition, while certain aspects of the invention are presented at times in certain claim forms, or may not be embodied in any claims at some times, the inventors contemplate the various aspects of the invention in any available claim form. For example, while only some aspects of the invention may be recited at a particular time as being embodied in a computer-readable medium, other aspects may likewise be so embodied.

What is claimed is:

1. A wearable computing system, comprising:
a strap designed to be worn around at least a portion of a body part of a human, wherein the strap includes one or more enclosures configured to each enclose one or more removable computing components;
one or more computing component connector interfaces carried by the strap, wherein each of the one or more enclosures includes at least a portion of at least one of the computing component connector interfaces, and wherein the at least portion of the computing component connector interface included in an enclosure is configured to removably physically and communicatively couple thereto a respective removable computing component enclosed in that enclosure;
one or more access point interfaces carried by the strap that are separate from the one or more enclosures and that enable one or more devices separate from the strap to communicatively couple with the strap;
one or more wiring connection mechanisms carried by the strap to inter-connect the one or more access point interfaces with the at least portion of the at least one computing component connector interface included in at least one of the one or more included enclosures; and
multiple removable computing components that are each enclosed in one of the enclosures in a manner that communicatively couples the removable computing component with at least one of the wiring connection mechanisms included in the strap via at least one of the computing component connector interfaces, the multiple removable computing components further being communicatively coupled together via the one or more enclosures.

2. The computing system of claim 1 wherein the strap comprises a flexible substrate having a first end and having a second end opposed to the first end, the first end and the second end being detachably coupleable to one another to enclose the portion of the body part of the human around which the strap is worn.

3. The computing system of claim 2 wherein the strap is a belt worn around a waist part of a human body.

4. The computing system of claim 1 wherein in use the strap forms a closed surface having an opening with an adjustable size to enable a length of the strap to be modifiable so as to enable attachment to multiple distinct human body parts of one or more humans at distinct times.

5. The computing system of claim 1 wherein the strap is designed to be worn as at least one of a strap of a bag worn over one or more of a shoulder of a human body and of an arm of a human body, of a sash worn around a torso of a human body, of a tie worn around a neck of a human body, of part of suspenders worn over one or more shoulders of a human body, of a band worn around a head of a human body, and of part of a longitudinal portion of a piece of clothing worn by a human body.

6. The computing system of claim 1 wherein each of the one or more enclosures is formed in part by a portion of the strap and has an associated flap that is designed to provide access to the enclosure when the flap is open and to inhibit access to the enclosure when the flap is closed.

7. The computing system of claim 1 wherein the one or more enclosures included in the strap are a single enclosure, wherein the multiple removable computing components are an inter-connected chain that is insertable in the single enclosure as a single unit and is removable from the single enclosure as a single unit, and wherein the communicative coupling of the multiple removable computing components together via the one or more enclosures is based on physical inter-component connectors between adjacent computing components of the inter-connected chain.

8. The computing system of claim 1 wherein the one or more enclosures included in the strap are a series of multiple interconnected enclosures that each enclose a single one of the multiple removable computing components, the series of multiple enclosures being interconnected based on successive pairs of two enclosures in the series each being interconnected via an additional connection mechanism between the two enclosures.

9. The computing system of claim 1 wherein at least one of the one or more enclosures is part of a holster that is detachably coupled to the strap.

10. The computing system of claim 1 wherein at least one of the multiple removable computing components is designed to provide a specified amount of computing capabilities, and wherein at least one other of the multiple removable computing components is designed to provide one or more other capabilities that do not include computing capabilities, the one or more other capabilities including at least one of volatile memory capabilities, non-volatile storage capabilities, one or more input/output capabilities, and one or more communications capabilities.

11. The computing system of claim 1 wherein each of the multiple removable computing components is of a single standardized size, and wherein each of the one or more enclosures has a size that is based on the single standardized size of one or more of the multiple removable computing components.

12. The computing system of claim 1 wherein the computing system is designed in a ruggedized form such that one or more of at least a portion of the strap and of at least one of the multiple removable computing components is designed to protect the computing system from one or more designated conditions, the designated conditions including at least one of one or more environmental conditions and of one or more human-initiated conditions.

13. The computing system of claim 1 further comprising a wrist-mounted device that is communicatively coupled with at least one of the one or more access point interfaces via at least one wire, the wrist-mounted device being designed to provide one or more input/output capabilities for the computing system.

14. The computing system of claim 1 further comprising one or more devices separate from the strap that are communicatively coupled with at least one of the one or more access point interfaces, the one or more separate devices being designed to be at least one of worn and carried by the human around whose body part the strap is worn.

15. The computing system of claim 1 wherein the multiple removable computing components are communicatively coupled together in such a manner as to aggregately provide one or more capabilities, the provided one or more capabilities including speech recognition capabilities to enable the human to provide voice-based commands to the computing system.

16. The computing system of claim 1 wherein one or more of the multiple removable computing components provide communication capabilities that enable interactions with multiple other computing systems being worn by a group of multiple humans operating in at least one of a proximate manner and a coordinated manner, and wherein the computing system is part of a distributed system that includes the multiple other computing systems.

17. The computing system of claim 1 wherein the multiple removable computing components are communicatively coupled together in such a manner as to aggregately provide one or more capabilities, the provided one or more capabilities being configured for use in activities by the human involving at least one of a healthcare role, a military role, a law enforcement role, a security role, and a firefighting role.

18. A method of using the computing system of claim 1, comprising:
attaching the strap of the computing system around at least a portion of a body part of a human; and
activating the multiple removable computing components of the computing system to aggregately perform one or more activities on behalf of the human, the one or more activities including at least one of providing output information to the human and of obtaining and using input information from at least one of the human and of an environment in which the human is located.

19. A computing system, comprising:
a flexible substrate designed to be carried by a human while a body of the human is in motion, wherein the flexible substrate includes one or more enclosures configured to each hold one or more removable computing components; and
multiple removable computing components that are each enclosed in one of the enclosures in a manner that communicatively couples the multiple removable computing components together via the one or more enclosures to enable the multiple removable computing components to aggregately provide one or more capabilities, one or more of the multiple removable computing components further being communicatively coupled with one or more devices separate from the strap that provide at least one of output capabilities to the human and of input capabilities using input information from at least one of the human and of an environment in which the human is located, the aggregately provided one or more capabilities including the at least one of the output capabilities and of the input capabilities.

20. The computing system of claim 19 wherein the flexible substrate is part of a strap that is designed to be worn around at least a portion of a body part of the human, wherein the one or more enclosures are configured to enclose the one or more removable computing components being held, wherein the strap further includes one or more access point interfaces separate from the one or more enclosures to enable the one or more devices separate from the strap to communicatively couple with the strap, and wherein the strap includes one or more wiring connection mechanisms to inter-connect the one or more access point interfaces with the one or more included enclosures.
